(19) United States
(12) Patent Application Publication
(10) Pub. No.: US 2023/0142882 A1
(43) Pub. Date: May 11, 2023

(54) STEP WITHOUT VISIBLE LEGS FOR USE AT HOME AND OFFICE

(71) Applicant: Emilio Jaime RUBIO GARCÍA, Reinach (CH)

(72) Inventor: Emilio Jaime RUBIO GARCÍA, Reinach (CH)

(21) Appl. No.: 17/736,522

(22) Filed: May 4, 2022

(30) Foreign Application Priority Data
Nov. 10, 2021 (ES) 202132225

(51) Int. Cl. E06C 1/00

(52) U.S. Cl. CPC E06C 1/005

(57) ABSTRACT

It is an integrated step stool at home and office spaces. It is an autonomous model, without visible legs when unfolded. It is developed to hold up all efforts when stepping in as well as all efforts coming from its parts. Can be installed without consuming current usable space, so unnecessary use of extra space by external devices is avoided. Step up exceeds the mark of 50 centimeters and can reach even higher. It consists of a rigid structure that supports 2 steps which overlap, slide and fold through some bearings until the end of the structure, decreasing the space occupied by the invention. The invention is fixed where the user cannot see, thus giving the impression the steps hold off in the air.

### INDUSTRIAL APPLICATION

Usable space at home is a critical element, regardless of the size of the house.

Even the people living in big mansions, eventually end up having problems to store everything that accumulates in a life time which is difficult to get rid-off for different reasons.

Even so more often, furniture producers design ingenious modular solutions to enable further storage of clothing or else, which will not be used immediately. There is a clear trend in the market pushing towards the improved use of the space in height, which implies that it is not always easy to access belongings and therefore, we have to make use of external tools, such as chair, stools or ladders.

The installation of wardrobes of great height to make good use of higher ceilings is something more and more frequent in the current design of furniture for households, as well as for offices.

In addition, the height of some people, as well as children, makes it more difficult to reach certain high places at home or in the office.

Despite there are alternatives such as stools, steps, fixed or movable ladders, etc. all of them present the inconvenience of space consumption as well limits in their reach. Most of them cannot be over dimensioned and present the clear problem of where to be stored when not in use. On top of that, most of them can carry additional burden in terms of safety of use, due to the fact that they have not been design for such use, potentially being a hazardous source for accidents.

### PRIOR TECHNIQUE STATUS

The invention is directed towards its use as an integrated step stool at home and office spaces. Specifically, it is geared towards its use as an integrated autonomous stool. In such design way, the use of unnecessary storage space or not-fit-for-purpose devices is avoided.

There are several patents, such as FR2972621, GB2462462 or U.S. 2015001005 that describe objects type stool or steps to access spaces in height. However, all of them summarize in a couple of steps, attached to the floor through some legs and that end up occupying more space that its own. Our invention is simpler and has visible advantages in its use and manufacturing.

### EXPLANATION OF THE INVENTION

The invention is directed towards its use as an integrated step stool at home and office spaces. This is an autonomous model, without visible legs when unfolded. It is developed to hold up all efforts when stepping in as well as all efforts coming from its parts. It is integrated and can be installed without consuming current usable space, so unnecessary use of extra space by external devices is avoided. Step up exceeds the mark of 50 centimeters and can reach even higher.

It consists of a rigid structure that supports 2 steps which overlap, slide and fold through some bearings until the end of the structure, decreasing the space occupied by the invention. The invention is fixed where the user cannot see, thus giving the impression the steps hold off in to the air.

### BRIEF DESCRIPTION OF DRAWINGS

FIG. 1 shows the invention in its open position with the components narrative.

FIG. 2 shows a perspective of the same invention with a posterior view.

### DETAILED EXPLANATION

This model is divided in two parts: Steps and support structure. Steps act as support for the user, meanwhile the structure secures the combined weight of steps and user. The invention is embedded inside a furniture made out of one or multiple drawers.

Firstly, the invention is positioned at the height of use, so its use is more ergonomic, providing a better user experience avoiding excessive flex.

Due to its positioning, it provides a high lift, thus enabling the user to properly access greater heights. Installation is recommended to not exceed excessive heights for comfort of use and safety.

Secondly, the support structure presents a dual role, enabling the support of the steps as well as the user plus cargo up to 180 kg (limited to 180 kg for safety reasons)

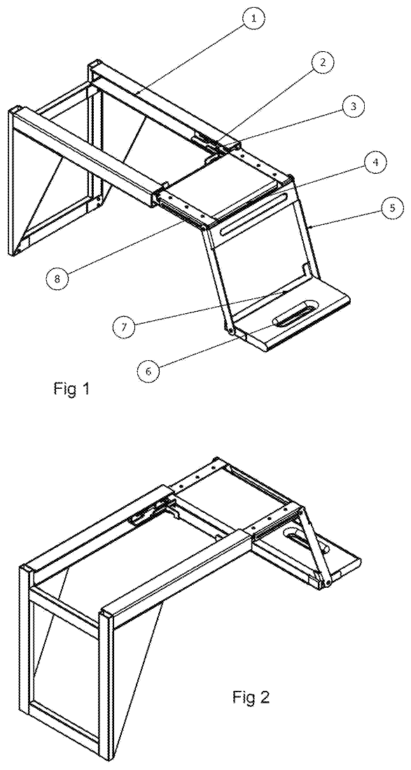

In FIG. 1 the invention components are detailed. The smoldered and screwed support structure, 1, is the guide as sustains 2 steps and the movement system. The step has a bearing, 2, that serve for an easy movement through the structure thus guiding the steps, integrated in the design. Underneath, we can find the smoldering assembly, 3, which function is to hold both the upper step, 4, as well as the bearings, 2. A strip, 5, connects the upper step, 4, with the lower step, 6. This union assures a fluid movement versus the structure as it allows for a turn of the lower step, 6, so it may remain at the same height of the upper step, 4. The turn is possible due to a screwed hinge, 7, which allows for the strip to move. The strip is also connected to the base of the upper step, 8. In summary, the system allows that strip and lower step rotate, to reach maximum extension so the lower step gets over the upper step. Once folded, and bath steps in the same plane, the bearings, 2, allow the steps to move towards the metallic structure, 1. Once all is together, it becomes a stable and solid structure, and it can be hidden as a drawer. Visually integrated in the furniture as if it did not exists.

When the invention is unfolded, the user and cargo weight is push by design to the metallic structure and to the wall that it is anchored. This enables the invention to be very stable, due to to the different force pairs which neutralize among them.

What is claimed is:

1. A rigid metallic structure, comprising:
a support structure coupled to a bearing;
a smoldering assembly installed within the support structure via the bearing, wherein the smoldering assembly is mounted with an upper step and the bearing facilitates movement of the smoldering assembly and the upper step through the support structure; and
a strip attached at one end to a lower step using a screwed hinge, wherein the screwed hinge enables movement to align the lower step and the strip above the upper step of the smoldering assembly, and the bearing facilitates movement of the smoldering assembly, the lower step, and the strip inside the support structure.

2. The rigid metallic structure of claim 1, wherein the strip is coupled to the smoldering assembly using the screwed hinge, to facilitate the movement of the strip along a plane of the smoldering assembly.

3. The rigid metallic structure of claim 1, wherein the upper step and the lower step when folded together is hidden inside a drawer, so that the support structure is not visible to a user.

4. The rigid metallic structure of claim 1, wherein the rigid metallic structure is embedded inside a furniture made of one or multiple drawers.

5. The rigid metallic structure of claim 1, wherein the upper step and the lower step overlap, fold, and slide inside the support structure using the bearings to decrease space occupied by the rigid metallic structure.

6. The rigid metallic structure of claim 1, wherein the support structure is screwed to wall to carry weight of a user.
